(19) United States
(12) Patent Application Publication
(10) Pub. No.: US 2025/0368874 A1
(43) Pub. Date: Dec. 4, 2025

(54) CONTAINER CLOSURES COMPRISING ONLY ONE POLYMER

(71) Applicant: ACTEGA DS GMBH, Bremen (DE)

(72) Inventors: Dany Mängel, Twistringen (DE); Matthias Kern, Lilienthal (DE)

(21) Appl. No.: 18/873,113

(22) PCT Filed: Dec. 20, 2022
(86) PCT No.: PCT/EP2022/086957

§ 371 Date: Dec. 9, 2024

(51) Int. Cl. C09K 3/10

(52) U.S. Cl. CPC C09K 3/1006; C09K 2200/0642

(57) ABSTRACT

A container closure, in particular a vacuum screw closure, having a scaling insert which comprises or consists of a polymer material (except for PVC), the sealing insert comprising essentially only one type of copolymer, preferably only one copolymer and in addition to this only conventional additives.

The invention in general relates to container closures with a sealing insert based on a polymer for bottles and other containers in order to hold beverages and foodstuffs. The container closures are free from halogenated materials and are also suitable for demanding applications.

Different types of containers are filled with beverages and foodstuffs for the purposes of transport and storage or safekeeping. Frequently, these containers have to be capable of being sealed so that the contents do not leak out and in addition, are protected from the ingress of unwanted materials which could contaminate or damage the contents. In many applications, these are not simply solid or liquid contaminants. If the contents are sensitive to gaseous substances, these also have to be prevented from gaining access. This is achieved by an appropriately configured container closure.

Container closures produced from metal and/or plastic have been known for a long time. In the form of screw caps, screw closures and crown corks, for example, they serve to tightly seal containers such as bottles, glasses and the like. Such containers have a mouth which has to be sealed by the container closure. In this regard, a sufficiently tight closure of the container has to be ensured in order on the one hand to prevent the container contents from leaking out, and on the other hand to protect the container contents from the ingress of unwanted materials, including gaseous substances such as oxygen, trichloroanisole and others.

The necessary imperviousness is usually achieved by means of a sealing insert which consists on the one hand of a sufficiently hard, but on the other hand also elastic material and is disposed in the container closure in a manner such that it comes into contact with the mouth of the container when the container closure is disposed on the container. The sealing insert is usually disposed on the inside of the container closure in the form of a disk or ring. In the closed state of the container, it is seated on the container mouth and is pressed against the mouth by the container closure, whereupon its hardness together with its elasticity makes the seal. In this regard, a good sealing insert compensates for the unevennesses of the container mouth which are always present. Thus, the more uneven is the container mouth, the higher are the demands placed on the sealing insert.

Sealing by means of a sealing compound can, if appropriate, be further optimized if it is foamed. Chemical blowing agents such as salts of citric acid, bicarbonates or microspheres filled with solvents (for example “Expancel”) may be used for foaming, as well as physical blowing agents such as CO₂ or nitrogen (N₂), which are introduced into the melt under high pressure during melting in the extruder. In contrast, previously employed chemical blowing agents based on semicarbazides or dicarbonamides are undesirable, because the by-products which are formed when they decompose are toxicologically harmful when in contact with foodstuffs.

An essential factor when meeting such stringent demands is the suitable choice of materials for the sealing insert. Many known materials are extremely suitable for relatively simple applications, but less so or entirely not so for more demanding seals.

In this regard, the sealing insert must also satisfy other requirements, for example they should be capable of being pasteurized or even sterilized for many purposes. They should (for example in the case of carbonated beverages) be able to withstand a considerable internal pressure which, however, if exceeded, should yield in a controlled manner (pressure relieving valve action).

If the container closure is a screw closure, the sealing insert must not have too much resistance to screwing the container closure off the mouth when opening.

In addition, the sealing insert should be able to be manufactured as cheaply and easily as possible and be affixed to the container closure. Cutting disk-shaped sealing inserts out of webs or films and then attaching them to the container closure (“out-shell moulding”) or, which is often preferred, introducing them into the container closure in a flowable form, then overmoulding it there and consolidating it (“in-shell moulding”), is known. In-shell moulding also means that sealing inserts can be produced which are not disk-shaped but are annular.

In the case of polymer-based sealing inserts, this is normally carried out by introduction as a liquid plastisol with subsequent moulding (optional) and drying at temperatures which, as a rule, are over 190° C., or in the case of thermoplastic materials by introduction in the heated, flowable state, subsequent moulding and cooling.

While previously, PVC-containing sealing inserts were widely used, PVC and other halogenated materials now give rise to considerable concerns. They are considered to be potentially harmful to health and are also difficult to dispose of easily. In many countries, the use of such halogenated materials is regulated by law or regulations, or even prohibited.

Thus, there is a considerable need for container closures without halogenated materials which can be used without dispensing with the advantages in this regard of, for example, PVC-containing sealing inserts as regards processing, sealing properties, costs and the like.

Known sealing inserts usually consists of mixtures (also known as “compounds”) of different polymers, often different types of polymers. We shall hereinafter describe different polymers which, however, are based on the same or homologous monomers as being “different”, but not as being “different types”. Thus, for example, all co-polypropylenes which contain only propylene and another olefin are different, but not “different types”, while PP copolymers and SEBS are different types.

Known sealing inserts usually comprise a base material, often a polyolefin, which in itself already comes close to having the required catalogue of properties. The properties of the sealing insert are then specifically adjusted by mixing in other polymers in order to optimise those properties further as regards elasticity or temperature resistance with respect to the purpose.

Most compounds with only one polymer (apart from glide agents, stabilizers and the like), in contrast, are not suitable for the purposes of the invention. Compounds with a non-elastomeric thermoplastic (for example most PP types) as the only polymer in the sealing insert are much too hard and not elastic enough. In contrast, compounds with only an elastomeric thermoplastic or thermoplastic elastomer, are usually too soft.

Certain PP-based copolymers form an exception; they can be processed into a sealing insert in accordance with the invention with quantities of the usual glide agents etc. Such compounds have been described in the patent claims.

The PP-based copolymer forms the main component of the sealing compound, which preferably contains no (or only a very small amount of) other polymers. In other words, the only polymer which forms the sealing element (apart from conventional additives) is practically entirely or entirely responsible for its properties.

In accordance with the invention, therefore, a container closure is provided, in particular a vacuum screw closure, with a sealing element which comprises or consists of a polymer material, wherein the sealing element substantially comprises a single type of copolymer, preferably a single copolymer and in addition only conventional additives.

In a preferred embodiment, the polymer material comprises or is a PP-based copolymer, in particular a bipolymer or a terpolymer.

Particularly preferably, the sealing insert comprises at least one PP/PE bipolymer (copolymer of propylene and ethylene). Alternatively, it may comprise a PP/PE/BU terpolymer (copolymer of propene, ethene and butene).

In preferred embodiments of the invention, the container closure has a sealing insert in which the copolymer has a MFR (ASTM D 2240) of less than 10, preferably less than 8 and particularly preferably ≤6 g/10 min at 230° C. and 2.16 kg loading.

In addition, preferred embodiments of the invention provide a container closure in which the copolymer has a Shore A hardness (ISO 868) of less than 80 and preferably more than 60.

In other or the same preferred embodiments, a container closure is provided in which the copolymer has a melting point (ISO 11357-3) of between 140° C. and 190° C., preferably between 160° C. and 180° C., and particularly preferably a maximum of 165° C.

In preferred embodiments of the invention, the container closure comprises a copolymer with a density (DIN EN ISO 1183-1) of 0.8 to 1.0, preferably 0.86 to 0.9 g/cm³, and especially approximately 0.88 g/cm³.

In addition to the polymer, the sealing inserts of the invention are preferably provided with the usual additives which are selected from glide agents, antioxidants, colorants and/or fillers.

Suitable polymers for carrying out the invention can be obtained from Mitsui Chemicals Group and from LyondellBasell.

Sealing inserts manufactured from the materials described can be used for fatty filling materials and are suitable for PT caps. They can also be sterilized. The suitability of the sealing material for sterilization can be determined by means of appropriate tests.

A prediction of this suitability is possible by means of Dynamic Mechanical Thermoanalysis (DMTA), which is known. In principle, the heating curve is determined for the phase angle (tan delta) the point of inflection of which must be sufficiently above (usually at least 10° C.) the intended sterilization temperature.

A validation of these tests is carried out by manufacturing the closure and testing using the appropriate application parameters, such as the maximum sterilization temperature, sterilization duration (=time at maximum sterilization temperature) and counter-pressure.

1. A vacuum screw closure, comprising a container closure with a sealing insert which comprises a polymer material (with the exception of PVC), wherein the material of the sealing insert substantially comprises or consists of a single type of copolymer.

2. The vacuum screw closure as claimed in claim 1, in which the polymer material substantially comprises or is consists of a PP-based copolymer.

3. The vacuum screw closure as claimed in claim 1, in which the polymer material substantially comprises or consists of a bipolymer or a terpolymer.

4. The vacuum screw closure as claimed in claim 1, in which the polymer material substantially comprises or consists of at least one PP/PE bipolymer (copolymer of propene and ethene).

5. The vacuum screw closure as claimed in claim 1, in which the polymer material substantially comprises or consists of a PP/PE/BU terpolymer (copolymer of propene, ethene and butene).

6. The vacuum screw closure as claimed in claim 1, in which the copolymer has a MFR (DIN EN ISO 1133) of less than 10 g/10 min at 230° C. and 2.16 kg loading.

7. The vacuum screw closure as claimed in claim 1, in which the copolymer has a Shore A hardness (determined in accordance with DIN ISO 7619-1) of less than 80.

8. The vacuum screw closure as claimed in claim 1, in which the copolymer has a melting point (DIN EN ISO 11357-3) of between 140° C. and 190° C.

9. The vacuum screw closure as claimed in claim 1, in which the copolymer has a density (DIN EN ISO 1183-1) of 0.8 to 1.0 g/cm3.

10. The vacuum screw closure as claimed in claim 1, comprising one or more additives selected from glide agents, antioxidants, colorants and/or fillers.

11. The vacuum screw closure as claimed in claim 1, in which the sealing material is a closed-pore foam, so that the density in accordance with DIN EN ISO 1183-1 is lower than the initial density of the sealing material, but still at least 50% of the initial density.

12. The vacuum screw container closure as claimed in claim 1, wherein the material of the insert comprises a single copolymer.

13. The vacuum screw closure as claimed in claim 1, in which the copolymer has a MFR (DIN EN ISO 1133) of less than 8 g/10 min at 230° C. and 2.16 kg loading.

14. The vacuum screw closure as claimed in claim 1, in which the copolymer has a MFR (DIN EN ISO 1133) of less than 6 g/10 min at 230° C. and 2.16 kg loading.

15. The vacuum screw closure as claimed in claim 1, in which the copolymer has a Shore A hardness (determined in accordance with DIN ISO 7619-1) of less than 80-and more than 70.

16. The vacuum screw closure as claimed in claim 1, in which the copolymer has a melting point (DIN EN ISO 11357-3) of between 160° C. and 180° C.

17. The vacuum screw closure as claimed in claim 1, in which the copolymer has a density (DIN EN ISO 1183-1) of 0.86 to 0.9 g/cm3.
